(19) United States
(12) Patent Application Publication
(10) Pub. No.: US 2015/0230227 A1
(43) Pub. Date: Aug. 13, 2015

(54) NODES, SYSTEMS AND METHODS IN A CELLULAR NETWORK

(71) Applicant: TELEFONAKTIEBOLAGET L M ERICSSON (PUBL), Stockholm (SE)

(72) Inventors: Nianshan Shi, Jarfalla (SE); Anders Forssell, Uppsala (SE); Francisco Manzano, Stockholm (SE); Jose Luis Pradas, Stockholm (SE)

(21) Appl. No.: 14/432,274

(22) PCT Filed: Oct. 7, 2013
(86) PCT No.: PCT/SE2013/051177

§ 371 Date: Mar. 30, 2015

Related U.S. Application Data
(60) Provisional application No. 61/710,954, filed on Oct. 8, 2012.

(51) Int. Cl. H04W 72/04

(52) U.S. Cl. CPC H04W 72/0406; H04W 88/12

(57) ABSTRACT

The present disclosure relates to a base transceiver station, node B, a method and a controlling Radio Network Controller, CRNC, for setting up common Enhanced Dedicated Channel, E-DCH, resources in a cellular network. In one embodiment, the node B is arranged to configure the common E-DCH resources comprising deciding at least one E-DCH Radio Network Transaction Identifier, E-RNTI, range for the common E-DCH resources, and to send the at least one E-RNTI range for the common E-DCH resources to a Controlling Radio Network Controller, CRNC. Thereby, the common E-DHC resources are set up.

### TECHNICAL FIELD

Embodiments of the present disclosure relate to a node arranged to set up common Enhanced Dedicated Channel resources in a cellular network, the node being for example a Base transceiver station or a Controlling Radio Network Controller.

Embodiments of the present disclosure further relate to a method and system for setting up common Enhanced Dedicated Channel resources in a cellular network.

### BACKGROUND

A network according to standard like 3GPP comprises a Core Network, CN, Radio Access Networks, RAN, and User Equipments, UE, attached to a RAN, such as the UMTS Terrestrial Radio Access Network, UTRAN, architecture.

In a typical cellular radio system, wireless terminals communicate via a radio access network, RAN, with one or more core networks. The wireless terminals can be mobile stations or other types of user equipment, UE, such as portable, pocket, hand-held, computer-included, or car-mounted mobile devices which communicate voice and/or data with radio access network, e.g., mobile telephones and laptops with wireless capability.

The RAN covers a geographical area which is divided into cell areas, with each cell area or group of cell areas being served by a radio access node. A cell is a geographical area where radio coverage is provided by equipment at the radio access node. Each cell is identified by an identity within the local radio area. The radio access nodes communicate over the air interface with the UE within the cells served by the node.

The Universal Mobile Telecommunications System, UMTS, is a third generation mobile communication system, which evolved from the Global System for Mobile Communications, GSM, and is intended to provide improved mobile communication services based on Wideband Code Division Multiple Access , WCDMA, access technology. UTRAN is essentially a radio access network using wideband code division multiple access for user equipment units, UEs.

In 3GPP Release 8, Enhanced Uplink in CELL_FACH was introduced to improve the end user performance of the CELL_FACH state. E-DCH is used as the uplink transport channels providing much higher bandwidth for UEs in CELL_FACH state. There is a common pool of E-DCH (Enhanced Dedicated Channel) resources (referred as “common E-DCH resources.”) shared by the Enhanced Uplink CELL FACH users, while each user would get an E-RNTI (Enhanced Dedicated Channel Radio Network Transaction Identifier) when accessing the common E-DCH (Enhances Dedicated Channel) resources.

In current specifications the common E-DCH (Enhanced Dedicated Channel) configurations are set up with NBAP (Node B Application Part) messages. An E-RNTI (Enhanced Dedicated

Channel Radio Network Transaction Identifier) list is managed by the Node-B, however, it is RNC who grants the CELL_FACH E-RNTI and RNC send it to the UE through certain (e.g. cell update, Radio Bearer Reconfiguration) Radio Resource Control Protocol, RRC, messages.

When common E-DCH (Enhanced Dedicated Channel) resource is setting up, in the current specification, Base transceiver station (Node B) would pre allocate E-DCH Radio Network

Transaction Identifiers (E-RNTIs) to be used for Cell FACH users and send all the E-RNTI in a list, called E-RNTI List to its CRNC (Controlling Radio Network Controller) in a NBAP “PHYSICAL SHARED CHANNEL RECONFIGURATION RESPONSE” message.

One object of the embodiments of the disclosure is to improve communication in a Radio Access Networks, RAN.

### SUMMARY

This has in accordance with a first embodiment been achieved by means of a base transceiver station, node B, arranged to set up common Enhanced Dedicated Channel, E-DCH, resources in a cellular network. The node B is arranged to configure the common E-DCH resources. The configuration of the common E-DCH resources comprises deciding at least one E-DCH Radio Network Transaction Identifier, E-RNTI, range for the common E-DCH resources and to send the at least one E-RNTI range for the common E-DCH resources to a Controlling Radio Network Controller, CRNC, so as to set up the common E-DHC resources.

One advantage with this embodiment is that the base transceiver station, node B, decides the E-RNTIs for the common E-DCH resources. The Controlling Radio Network Controller does not need to confirm this decision.

Further, as the base transceiver station, node B, sends the at least one E-RNTI range for the common E-DCH resources to the Controlling Radio Network Controller, CRNC, the amount of information sent to the CRNC is independent of the number of E-RNTIs within the range. Accordingly, the amount of information sent to the CRNC is independent of the number E-DCH Cell FACH users.

Further, Node B Application Part, NBAP, efficiency can be improved.

In one option, each at least one range comprises two values representing the start and end of the E-RNTI value for the common E-DCH resources.

In one option, node B is arranged to send the at least one E-RNTI range in a Node B Application Part, NBAP, message. In one example, the node B is arranged to send the at least one E-RNTI range in a NBAP message as new protocol Information Elements (IEs).

In one option, the node B comprises a processor arranged to configure the common E-DCH resources comprising deciding the at least one E-RNTI ranges for the common E-DCH resources to use, a memory arranged to store information about the decided E-RNTI ranges for the common E-DCH resources to use, and communication circuitry arranged to send the at least one range of the E-RNTI for the common E-DCH resources to the CRNC.

One embodiment of the present disclosure relates to a system for setting up common Enhanced Dedicated Channel (E-DCH) resources in a cellular network. The system comprises at least one base transceiver station, node B, and at least one controlling Radio Network Controller, CRNC. The at least one node B is arranged to configure the common E-DCH resource comprising deciding at least one E-DCH Radio Network Transaction Identifier, E-RNTI, range for the common E-DCH resources to use and to send the at least one E-RNTI range for the common E-DCH resources to its CRNC, so as to set up the common E-DHC resources. Each range may comprise two values representing the start and end of the E-RNTI value for the common E-DCH resources.

At least one node B is in one option arranged to send the at least one E-RNTI ranges in a Node B Application Part, NBAP, message as new protocol information elements (IEs).

At least one node B comprises in one option a processor arranged to configure the common E-DCH resource comprising deciding the at least one E-RNTI range for the common E-DCH resources to use, a memory arranged to store information about the decided at least one E-RNTI range for the common E-DCH resources to use, and communication circuitry arranged to send the at least one E-RNTI range for the common E-DCH resources to the CRNC.

In one option, the CRNC is arranged to receive the range of the E-RNTI for the common E-DCH resources provided by the node B and to allocate the E-RNTI within the at least one range provided by the node B for the common E-DCH users.

In one option, the CRNC comprises communication circuitry arranged to receive the at least one E-RNTI range for the common E-DCH resources provided by the node B and a processor arranged to allocate the E-RNTI within the at least one range for the common E-DCH users provided by the node B.

In one option, the cellular network is a UMTS Terrestrial Radio Access Network (UTRAN).

One embodiment of the present disclosure also relates to a method in a cellular network for setting up common Enhanced Dedicated Channel, E-DCH, resources. The method comprises performing at a node B the steps of configuring the common E-DCH resource comprising deciding at least one E-DCH Radio Network Transaction Identifier, E-RNTI, range for the common E-DCH resources to use and sending the at least one E-RNTI range for the common E-DCH resources to a Controlling Radio Network Controller, CRNC.

In one option, the at least one range comprises each two values representing the start and end of the E-RNTI value for the common E-DCH resources.

In one option, the method comprises performing at the CRNC the steps of receiving the at least one E-RNTI range for the common E-DCH resources provided by the node B and allocating the E-RNTI within the at least one range provided by the node B for the common E-DCH users.

One embodiment of the present disclosure relates to a controlling Radio Network Controller, CRNC, arranged to set up common Enhanced Dedicated Channel, E-DCH, resources in a cellular network. The CRNC is arranged to configure the common E-DCH resources. The configuration comprises pre-deciding at least one E-DCH Radio Network Transaction Identifier, E-RNTI, range for the common E-DCH resources and informing a Base transceiver station, node B, about the pre-decided at least one range for the common E-DCH resources.

One advantage with this embodiment is that the amount of information sent from the CRNC to Node B is independent of the number of E-RNTIs within the range. Accordingly, the amount of information sent to the CRNC is independent of the number E-DCH Cell FACH users.

One embodiment of the present disclosure relates to a system for setting up common Enhanced Dedicated Channel, E-DCH, resources in a cellular network. The system comprises at least one Base transceiver station, node B, and at least one controlling Radio Network Controller, CRNC. The at least one CRNC is arranged to configure the common E-DCH resources. The configuration comprises pre-deciding at least one E-DCH Radio Network Transaction Identifier, E-RNTI, range for the common E-DCH resources and to inform a Base transceiver station, node B, about the at least one E-RNTI range for the common E-DCH resources. The node B is then arranged to coordinate the at least one E-RNTI range for the common E-DCH resources decided by the CRNC and an E-DCH Radio Network Transaction, E-RNTI, for Cell Dedicated Channel, DCH, users and based thereon determine whether the at least one E-RNTI range for the common E-DCH resources pre-decided by the CRNC is acceptable.

In one option, the node B is arranged to accept the at least one range without responding to the CRNC when the at least one E-RNTI range for the common E-DCH resources is determined to be acceptable.

In one option, the node B is arranged to actively confirm the at least one range in a response to the CRNC when the at least one E-RNTI range for the common E-DCH resources is determined to be acceptable.

In one option, the node B is arranged to provide at least one proposed new E-RNTI range for the common E-DCH resources and to comprise the at least one proposed new range in a response to the CRNC when the at least one E-RNTI range for the common E-DCH resources is determined not to be acceptable.

One embodiment of the present disclosure relates to a method for setting up common Enhanced Dedicated Channel, E-DCH, resources. The method comprises configuring at a Controlling Radio Network Controller, CRNC, the common E-DCH resource, said configuring comprising pre-deciding at least one E-DCH Radio Network Transaction, E-RNTI, range for the common E-DCH resources to use, and sending the at least one E-RNTI range for the common E-DCH resources to a Base transceiver station node B.

In one option, the method further comprises a step of receiving at the CRNC a response from the node B to the sent at least one E-RNTI range for the common E-DCH resources. The response may be a confirmation message. Alternatively, the response may comprise a proposed new range.

In one option, the method comprises steps of receiving at the node B the pre-decided at least one E-RNTI range for the common E-DCH resources provided by the CRNC, and evaluating at node B the received pre-decided at least one range, and based on the evaluation determining the at least one E-RNTI range for the common E-DCH resources.

In one option, the method further comprising a step of node B transmitting a confirmation response to the CRNC based on the evaluation.

In one option, node B forms at least one proposed new range based on the evaluation and transmits the proposed at least one new range to the CRNC.

### BRIEF DESCRIPTION OF THE DRAWINGS

FIG. 1 is a block diagram of an example of a network.

FIG. 2 is a flow chart illustrating a method performed at node B for setting up common E-DCH resource in accordance with a first solution.

FIG. 3 is a flow chart illustrating a method performed at CRNC for setting up common E-DCH resource in accordance with said first solution.

FIG. 4 is a flow chart illustrating a method performed at node B for setting up common E-DCH resource in accordance with a second solution.

FIG. 5 is a flow chart illustrating a method performed at CRNC for setting up common E-DCH resource in accordance with said second solution.

FIG. 6 is a block diagram schematically illustrating an example of a node B in the network of FIG. 1.

FIG. 7 is a block diagram schematically illustrating an example of a CRNC in the network of FIG. 1.

### DETAILED DESCRIPTION

A network according to standard like 3GPP comprises a Core Network, CN, Radio Access Networks, RAN, and User Equipments, UE, attached to a RAN, such as the UMTS Terrestrial Radio Access Network, UTRAN, architecture.

In a typical cellular radio system, wireless terminals communicate via a radio access network, RAN, with one or more core networks. The wireless terminals can be mobile stations or other types of user equipment, UE, such as portable, pocket, hand-held, computer-included, or car-mounted mobile devices which communicate voice and/or data with radio access network, e.g., mobile telephones and laptops with wireless capability.

The RAN covers a geographical area which is divided into cell areas, with each cell area or group of cell areas being served by a radio access node. A cell is a geographical area where radio coverage is provided by equipment at the radio access node. Each cell is identified by an identity within the local radio area. The radio access nodes communicate over the air interface with the UE within the cells served by the node.

The Universal Mobile Telecommunications System, UMTS, is a third generation mobile communication system, which evolved from the Global System for Mobile Communications, GSM, and is intended to provide improved mobile communication services based on Wideband Code Division Multiple Access, WCDMA, access technology. UTRAN is essentially a radio access network using wideband code division multiple access for user equipment units, UEs.

FIG. 1 shows an exemplary network 100 like this, wherein the UTRAN comprises one or more Radio Network Controllers, RNCs, 101 and one or more Node B 102 (Radio Base Stations). The one or more Node B 102 is connected to the RNC 101 through an interface 103. The interface is denoted lub. A controlling Radio Network Controller, CRNC, (not specifically shown) is the RNC responsible for the configuration of a particular Node B. Thus, a User Equipment, UE, 106 accessing the system will send an access message to a Node B, which in turn will forward this message on to its CRNC. The UTRAN connects to the Core Network 104 through an interface 105. This interface is denoted lu. The UTRAN and the Core Network provide communication and control for a plurality of User Equipment.

In 3GPP Release 8, Enhanced Uplink, CELL_FACH (CELL Forward Access Channel) was introduced to improve the end user performance of the CELL_FACH state. E-DCH is used as the uplink transport channels providing much higher bandwidth for UEs in CELL_FACH state. There is a common pool of E-DCH resources (referred as “common E-DCH resources.”) shared by the Enhanced Uplink CELL FACH users, while each user would get an E-RNTI when accessing the common E-DCH (Enhances Dedicated Channel) resources.

In current specifications the common E-DCH (Enhanced Dedicated Channel) configurations are set up with NBAP (Node B Application Part) messages. An E-RNTI (Enhanced Dedicated Channel Radio Network Transaction Identifier) list is managed by the Node-B, however, it is RNC who grants the CELL_FACH E-RNTI and RNC send it to the UE through certain (e.g. cell update, Radio Bearer Reconfiguration) Radio Resource Control Protocol, RRC, messages.

When common E-DCH (Enhanced Dedicated Channel) resource is setting up, in the current specification, Base transceiver station (Node B) would pre allocate E-DCH Radio Network Transaction Identifiers, E-RNTIs, to be used for Cell FACH users and send all the E-RNTI in a list, called E-RNTI List to its CRNC (Controlling Radio Network Controller) in a NBAP “PHYSICAL SHARED CHANNEL RECONFIGURATION RESPONSE” message.

E-RNTI is defined as 16 bits. Thanks to the deployment of smart phones, the number of Sending of PHYSICAL SHARED CHANNEL RECONFIGURATION RESPONSE with hundreds and thousands of E-RNTI in the list would prior art solutions imply a high load on the system and a potential overload, e.g. NBAP congestion.

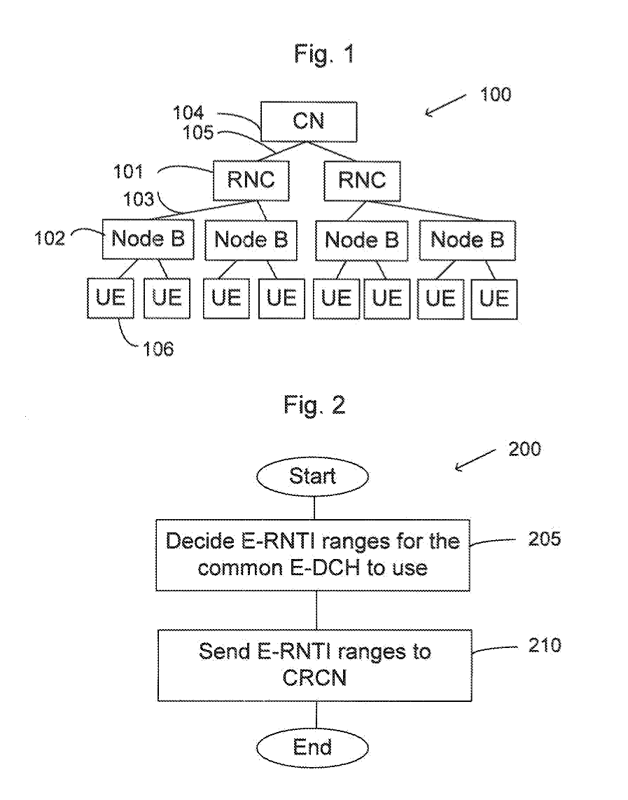

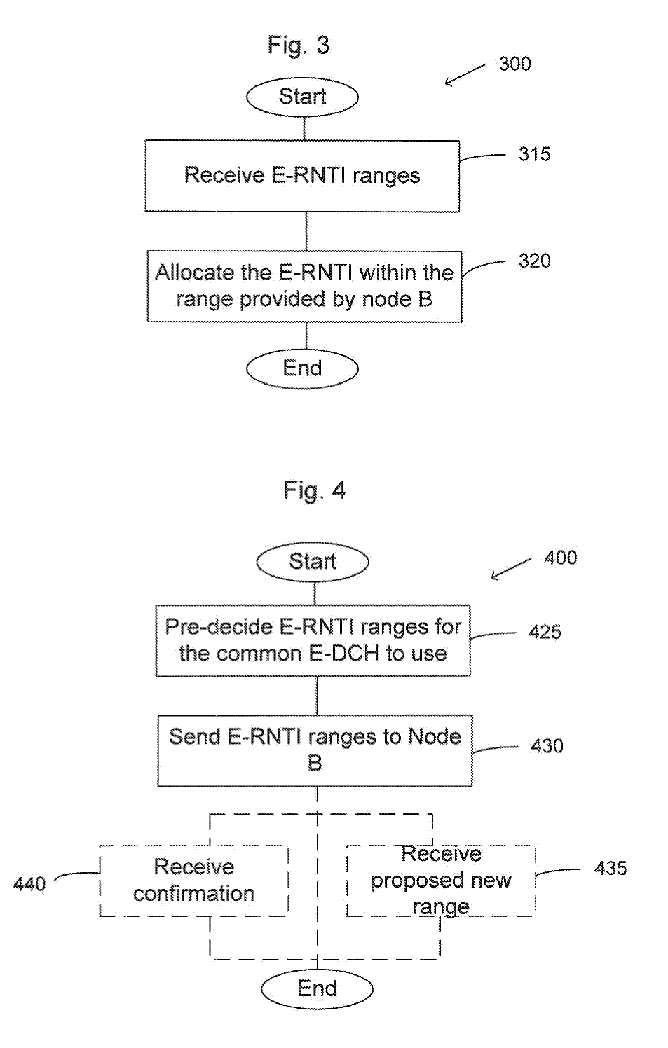

In FIGS. 2 and 3, one examplified first solution, denoted solution A, is based on that Node B decides the E-RNTI ranges for the common E-DCH resources to use. Node B sends then in one example the E-RNTI ranges in NBAP message. In one example, Node B sends the E-RNTI ranges in NBAP message as new protocol information elements (IEs). The ranges comprise for example each two values representing the start and end of the E-RNTI value for the common E-DCH resources. The E-RNTI ranges are in one example defined as for example as Common E-DCH E-RNTI Start, and Common E-DCH E-RNTI End, said two values indicating E-RNTIs between these two values can be used for common E-DCH E-RNTI. In one example, the new IE is defined in the existing NBAP message PHYSICAL SHARED CHANNEL RECONFIGURATION RESPONSE.

In one example, Node B decides one E-RNTI range. In an alternative example, Node B decides a plurality of E-RNTI ranges. Accordingly, a list comprising one or a plurality of E-RNTI ranges may be introduced, for use by the CRNC. Alternatively, the list is introduced in other NBAP common message, or new message. Instead, or in addition thereto the list is on one example introduced in lub user plan frames.

In FIG. 2, a method 200 performed at a base transceiver station (node B) for setting up common Enhanced Dedicated Channel (E-DCH) resource comprises in one example
configuring 205 the common E-DCH resource comprising deciding at least one E-DCH Radio Network Transaction Identified (E-RNTI) range for the common E-DCH resources to use and
sending 210 the least one range of the E-RNTI for the common E-DCH resources to a controlling Radio Network Controller (CRNC).

In one option, the at least one range comprises two values representing the start and end of the E-RNTI value for the common E-DCH resources.

In FIG. 3 a method 300 performed at a controlling Radio Network Controller (CRNC) for setting up common Enhanced Dedicated Channel (E-DCH) resources comprises in one example
receiving 315 at least one E-DCH Radio Network Transaction Identifier (E-RNTI) range for the common E-DCH resources provided by a base transceiver station (Node B) and
allocating 320 the E-RNTI within the at least one E-RNTI range provided by Node B for the common E-DCH users.

The tables 1 and 2 below illustrate an example wherein the new IE is defined in the existing NBAP message PHYSICAL SHARED CHANNEL RECONFIGURATION RESPONSE. Table 1 illustrates an example of Common E-DCH System Information Response included in PHYSICAL SHARED CHANNEL RECONFIGURATION RESPONSE. It provides information for E-DCH configured for UE in Cell_FACH and Idle state that have been established or modified.

TABLE 1
E-RNTI Range is introduced in Common E-DCH System Information Response

| | | | IE Type and | Semantics | | Assigned |
|---|---|---|---|---|---|---|
| IE/Group Name | Presence | Range | Reference | Description | Criticality | Criticality |
| UL Common MAC | | 1 . . . ><maxnoofCommonMACFlows>> | | | — | |
| Flow Specific | | | | | | |
| Information | | | | | | |
| Response | | | | | | |
| >UL Common MAC | M | | Common | | — | |
| Flow ID | | | MAC Flow ID | | | |
| | | | 9.2.2.79 | | | |
| >Binding ID | O | | 9.2.1.4 | | — | |
| >Transport Layer | O | | 9.2.1.63 | | — | |
| Address | | | | | | |
| Serving Grant Value | M | | INTEGER | (0 . . . 37) | — | |
| | | | (0 . . . 37, 38) | indicates | | |
| | | | | E-DCH serving | | |
| | | | | grant index as | | |
| | | | | defined in TS | | |
| | | | | 25.321 [32]; | | |
| | | | | Index 38 is not | | |
| | | | | allowed | | |
| E-RNTI List | O | | 9.2.2.139 | The Node B | YES | ignore |
| | | | | shall not | | |
| | | | | allocate any E- | | |
| | | | | RNTIs listed in | | |
| | | | | this IE for a UE | | |
| UE Status Update | O | | BOOLEAN | TRUE means | YES | ignore |
| Confirm Indicator | | | | that the Node B | | |
| | | | | supports UE | | |
| | | | | Status Update | | |
| | | | | Confirmation | | |
| | | | | Procedure | | |
| E-RNTI Range | O | | E-RNTI Range | | YES | ignore |

Table 2 illustrates an example of E-RNTI Range IE providing the range of E-RNTIs which can be allocated by CRNC when sent by Node B; it provides the range of E-RNTI used by CRNC when sent by CRNC.

TABLE 2
E-RNTI Range is defined with Common
E-DCH Start and Common E-DCH End

| | | | | |
|---|---|---|---|---|
| IE/Group | Pres- | | IE Type and | Semantics |
| Name | ence | Range | Reference | Description |

| | | |
|---|---|---|
| Common E-DCH Start | M | 9.2.1.75 |
| Common E-DCH End | M | 9.2.1.75 |

Table 3 below illustrates the introduction of a list of ranges, which can be used by CRNC E-RNTI Range. In the illustrated example, the E-RNTI Range IE provides the list of ranges of E-RNTIs which can be allocated by CRNC when sent by Node B; it provides the range of E-RNTI used by CRNC when sent by CRNC.

TABLE 3
E-RNTI Range is defined with a list of ranges

| | | | | |
|---|---|---|---|---|
| IE/Group | Pres- | | IE Type and | Semantics |
| Name | ence | Range | Reference | Description |

| | | | |
|---|---|---|---|
| E-RNTI | | 1 . . . <max | |
| Range | | noofERNTIRanges> | |
| >Common | M | | 9.2.1.75 |
| E-DCH Start | | | |
| >Common | M | | 9.2.1.75 |
| E-DCH End | | | |

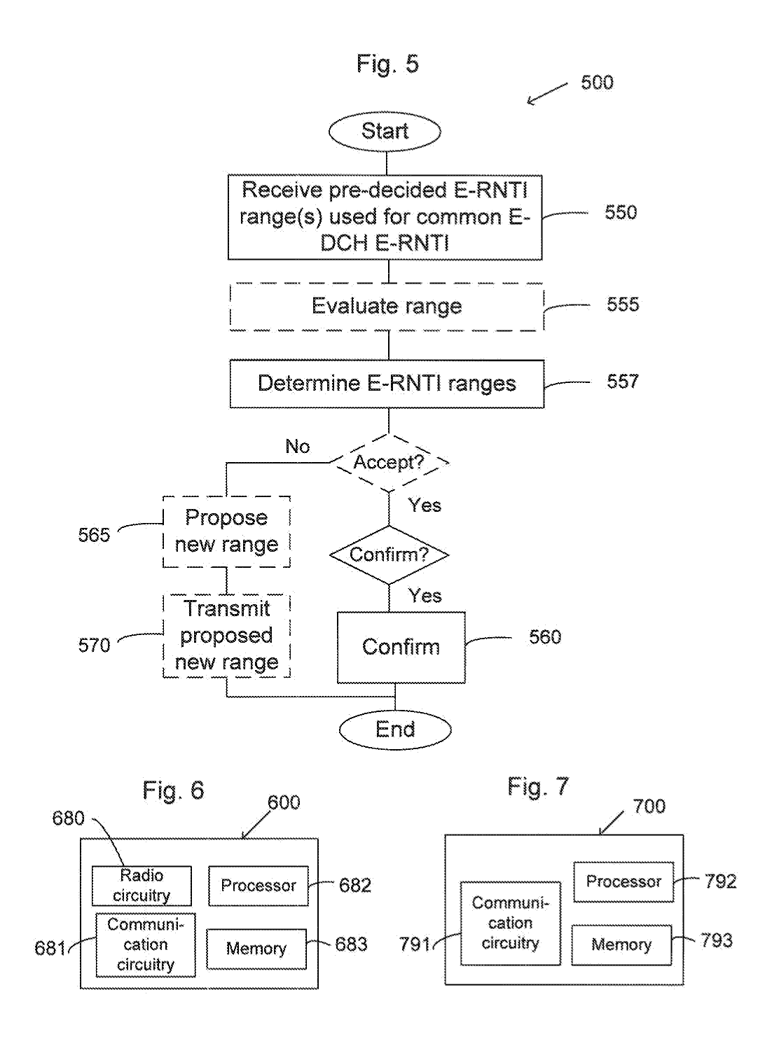

In FIGS. 4 and 5, one examplified second solution, denoted solution B, is based on that CRNC pre-decides the E-RNTI ranges for the common E-DCH resources. In one example the CRNC is arranged to send the E-RNTI ranges in NBAP message as new IE. This message indicates to Node B that the E-RNTI within the range will be used for common E-DCH E-RNTI by CRNC.

Node B has a few options for the handling. In a first option, Node B is arranged to do nothing, indicating the range is accepted and understood. In a second option, Node B is arranged to actively confirm to the CRNC indicating that the range is received and understood. In a third option Node B is arranged to propose a new range.

In one example, the new IE is defined in the existing NBAP message PHYSICAL SHARED CHANNEL RECONFIGURATION REQUEST. In one example, the new IE is introduced in other NBAP common message, or new message. In one example, the new IE is introduced in lub user plan frames. In FIG. 4 a method performed at a controlling Radio Network Controller (CRNC) for setting up common Enhanced Dedicated Channel (E-DCH) resources comprises in one example
configuring 425 the common E-DCH resources comprising pre-deciding at least one E-DCH Radio Network Transaction Identifier (E-RNTI) range for the common E-DCH resources to use and
sending 430 at least one E-RNTI range for the common E-DCH resources to the CRNC.

In one option, the method also involves receiving 435, 440 at the CRNC a response from Node B to the sent range of the E-RNTI for the common E-DCH resources. In one example the response 440 is a confirmation message. In an alternative example, the response 435 comprises at least one proposed new range. In yet another example, no response is received.

In FIG. 5, a method performed at a base transceiver station (node B) for setting up common Enhanced Dedicated Channel (E-DCH) resources comprises in one example
receiving 550 at least one pre-decided E-DCH Radio Network Transaction Identifier (E-RNTI) range for the common E-DCH resources provided by a controlling Radio Network Controller (CRNC).

In one option, the method comprises the steps of evaluating 555 the received pre-decided range. Node B transmits in one example a confirmation response 560. The confirmation response may be based on the evaluation. Node B forms 565 in one example at least one proposed new range based on the evaluation, and transmits 570 the proposed at least one new range to the CRNC.

The tables 1 and 2 above and 4 below illustrate an example wherein the new IE is defined in the existing NBAP message PHYSICAL SHARED CHANNEL RECONFIGURATION REQUEST.

Table 4 below illustrates the Common E-DCH System Information which is included in PHYSICAL SHARED CHANNEL RECONFIGURATION REQUEST.

TABLE 4
E-RNTI Range is introduced in Common E-DCH System Information

| | | | IE Type and | Semantics | | Assigned |
|---|---|---|---|---|---|---|
| IE/Group Name | Presence | Range | Reference | Description | Criticality | Criticality |
| Common E-DCH UL | | 0 . . . 1 | | | — | |
| DPCH Information | | | | | | |
| >UL SIR Target | M | | UL SIR | | — | |
| | | | 9.2.1.67A | | | |
| >DPC Mode | O | | 9.2.2.13C | If received, this | — | |
| | | | | IE shall be | | |
| | | | | ignored. DPC | | |
| | | | | mode 0 shall be | | |
| | | | | applied for | | |
| | | | | Common E- | | |
| | | | | DCH(see ref. TS | | |
| | | | | 25.214 [10]). | | |
| Common E-DCH E- | | 0 . . . 1 | | | — | |
| DPCH Information | | | | | | |
| >Maximum Set of E- | M | | 9.2.2.20C | | — | |
| DPDCHs | | | | | | |
| >Puncture Limit | M | | 9.2.1.50 | | — | |
| >E-TFCS Information | M | | 9.2.2.13Dh | | — | |
| >E-TTI | M | | 9.2.2.13Di | | — | |
| >E-DPCCH Power | M | | 9.2.2.13Dj | | — | |
| Offset | | | | | | |
| >E-RGCH 2-Index- | O | | 9.2.2.13lg | | — | |
| Step Threshold | | | | | | |
| >E-RGCH 3-Index- | O | | 9.2.2.13lh | | — | |
| Step Threshold | | | | | | |
| >HARQ Info for E- | M | | 9.2.2.18ba | | — | |
| DCH | | | | | | |
| Common E-DCH | | 0 . . . 1 | | | — | |
| Information | | | | | | |
| >E-DCH Reference | O | | 9.2.2.13Y | | — | |
| Power Offset | | | | | | |
| >E-DCH Power | O | | 9.2.1.85 | | — | |
| Offset for Scheduling | | | | | | |
| Info | | | | | | |
| >Maximum E-DCH | M | | ENUMERATED | Interms of TTIs, | — | |
| resource allocation | | | (8, 12, 16, | Value 120 | | |
| for CCCH | | | 24, 32, 40, 80, | should not be | | |
| | | | 120, . . . , 20) | used | | |
| >Maximum period | M | | INTEGER(8 . . . 24, . . . ) | Interms of TTIs | — | |
| for collision | | | | | | |
| resolution phase | | | | | | |
| >Maximum TB Sizes | O | | 9.2.2.106 | | — | |
| >Common E-DCH | M | | BOOLEAN | TRUE means | — | |
| implicit release | | | | implicit release | | |
| indicator | | | | is in use. FALSE | | |
| | | | | means implicit | | |
| | | | | release is not in | | |
| | | | | use. | | |
| >Common E-DCH | O | | INTEGER | | YES | ignore |
| Additional | | | (0 . . . 15, . . . ) | | | |
| Transmission Back | | | | | | |
| Off | | | | | | |
| Common E-DCH HS- | | 0 . . . 1 | | | — | |
| DPCCH Information | | | | | | |
| >ACK-NACK | M | | 9.2.2.a | | — | |
| Repetition Factor | | | | | | |
| >ACK Power Offset | M | | 9.2.2.b | | — | |
| >NACK Power Offset | M | | 9.2.2.23a | | — | |
| >Common E-DCH | O | | | | — | |
| CQI Information | | | | | | |
| >>CQI Feedback | M | | 9.2.2.21B | | — | |
| Cycle k | | | | | | |
| >>CQI Repetition | C- | | 9.2.2.4Cb | | — | |
| Factor | CQICycle k | | | | | |
| >>CQI Power | M | | 9.2.2.4Ca | | — | |
| Offset | | | | | | |
| >>Measurement | M | | 9.2.2.21C | | — | |
| Power Offset | | | | | | |
| Common E-DCH | | 0 . . . 1 | | | — | |
| Preamble Control | | | | | | |
| Information | | | | | | |
| >Common Physical | M | | 9.2.1.13 | | — | |
| Channel ID | | | | | | |
| >Common E-DCH | M | | Preamble | | — | |
| Preamble Signature | | | Signatures | | | |
| | | | 9.2.2.31 | | | |
| >Scrambling Code | M | | 9.2.2.42 | | — | |
| Number | | | | | | |
| >Preamble | M | | 9.2.2.32 | | — | |
| Threshold | | | | | | |
| >E-Al Indicator | O | | BOOLEAN | TRUE means E- | — | |
| | | | | Als are in use | | |
| | | | | on the AICH. | | |
| | | | | FALSE means E- | | |
| | | | | Als are not in | | |
| | | | | use on the | | |
| | | | | AICH. | | |
| >Common E-DCH | | 0 . . . 1 | | | — | |
| AICH Information | | | | | | |
| >>Common | M | | 9.2.1.13 | | — | |
| Physical Channel ID | | | | | | |
| >>AICH | M | | 9.2.2.1 | | — | |
| Transmission | | | | | | |
| Timing | | | | | | |
| >>FDD DL | M | | 9.2.2.14 | | — | |
| Channelisation | | | | | | |
| Code Number | | | | | | |
| >>AICH Power | M | | 9.2.2.D | | — | |
| >>STTD Indicator | M | | 9.2.2.48 | | — | |
| Common E-DCH F- | | 0 . . . 1 | | | — | |
| DPCH Information | | | | | | |
| >F-DPCH slot format | M | | 9.2.2.93 | | — | |
| >FDD TPC DL Step | M | | 9.2.2.16 | | — | |
| Size | | | | | | |
| >Initial DL | O | | DL Power | Initial power on | YES | ignore |
| Transmission Power | | | 9.2.1.21 | F-DPCH | | |
| >Maximum DL | O | | DL Power | Maximum | YES | ignore |
| Power | | | 9.2.1.21 | allowed power | | |
| | | | | on F-DPCH | | |
| >Minimum DL | O | | DL Power | Minimum | YES | ignore |
| Power | | | 9.2.1.21 | allowed power | | |
| | | | | on F-DPCH | | |
| Common E-DCH E- | O | | FDD DL | | — | |
| AGCH Channelisation | | | Channelisation | | | |
| Code Number | | | Code | | | |
| | | | Number | | | |
| | | | 9.2.2.14 | | | |
| Common E-DCH | | 0 . . . <maxnoofCommonEDCHs> | | | — | |
| Resource | | | | | | |
| Combination | | | | | | |
| Information | | | | | | |
| >Soffset | M | | INTEGER | | — | |
| | | | (0 . . . 9, . . . ) | | | |
| >F-DPCH DL Code | M | | FDD DL | | — | |
| Number | | | Channelisation | | | |
| | | | Code | | | |
| | | | Number | | | |
| | | | 9.2.2.14 | | | |
| >UL DPCH | M | | UL | | — | |
| Scrambling Code | | | Scrambling | | | |
| | | | Code | | | |
| | | | 9.2.2.59 | | | |
| >E-RGCH/E-HICH | M | | FDD DL | | — | |
| Channelisation Code | | | Channelisation | | | |
| | | | Code | | | |
| | | | Number | | | |
| | | | 9.2.2.14 | | | |
| >E-RGCH Signature | O | | INTEGER | | — | |
| Sequence | | | (0 . . . maxnoofSigSeqE- | | | |
| | | | RGHICH − 1) | | | |
| >E-HICH Signature | M | | INTEGER | | — | |
| Sequence | | | (0 . . . maxnoofSigSeqE- | | | |
| | | | RGHICH − 1) | | | |
| UL Common MAC | | 0 . . . <maxnoofCommonMACFlows> | | | — | |
| Flow | | | | | | |
| Specific Information | | | | | | |
| >UL Common MAC | M | | Common | | — | |
| Flow ID | | | MAC Flow ID | | | |
| | | | 9.2.2.79 | | | |
| >Transport Bearer | M | | 9.2.1.62A | | — | |
| Request Indicator | | | | | | |
| >Binding ID | O | | 9.2.1.4 | Shall be ignored | — | |
| | | | | if bearer | | |
| | | | | establishment | | |
| | | | | with ALCAP. | | |
| >Transport Layer | O | | 9.2.1.63 | Shall be ignored | — | |
| Address | | | | if bearer | | |
| | | | | establishment | | |
| | | | | with ALCAP. | | |
| >TNL QoS | O | | 9.2.1.58A | Shall be ignored | — | |
| | | | | if bearer | | |
| | | | | establishment | | |
| | | | | with ALCAP. | | |
| >Payload CRC | M | | 9.2.1.49 | | — | |
| Presence Indicator | | | | | | |
| >Bundling Mode | O | | 9.2.2.1Bb | | — | |
| Indicator | | | | | | |
| >Common E-DCH | M | | 9.2.2.105 | | — | |
| MAC-d Flow Specific | | | | | | |
| Information | | | | | | |
| E-RNTI List Request | O | | NULL | | YES | ignore |
| E-RNTI Range | O | | E-RNTI Range | | YES | ignore |

With the above described solutions A and B, the NBAP efficiency is improved in the handling of common E-DCH resources in PHYSICAL SHARED CHANNEL RECONFIGURATION RESPONSE. Further, with the above described solutions, RNC control of E-RNTI allocation for common E-DCH users is improved.

In FIG. 6, a base transceiver station (Node B) 600 comprises radio circuitry 680 to communicate with served User Equipment (Ues), communication circuitry 681 to communicate with other radio network and core network nodes, memory 683 to store information, and a processing unit 682. The memory 681 is configured to store information about served UEs, as well as information about neighbor cells.

In accordance with solution A, the processor 682 is arranged to configure common Enhanced dedicated channel (E-DCH) resource comprising deciding E-DCH Radio Network Transaction Identifier (E-RNTI) ranges for the common E-DCH resources to use. The memory is arranged to store information about the decided E-RNTI ranges for the common E-DCH resources to use. The communication circuitry 681 is arranged to send at least one range of the E-RNTI for the common E-DCH resources to a controlling Radio Network Controller (CRNC).

In accordance with solution B, the communication circuitry 681 is arranged to receive 550 at least one pre-decided range of the E-RNTI for the common E-DCH resources provided by CRNC. The at least one pre-decided range of the E-RNTI for the common E-DCH resources is stored in the memory 683. In one option, processor 682 is arranged to evaluate the received pre-decided at least one range. In one example, the communication circuitry 681 is arranged to transmit a confirmation response 560 to the CRNC. The confirmation response may be based on the evaluation. In one example, the processor 682 is arranged to form at least one proposed new range based on the evaluation, and the communication circuitry is arranged to transmit the proposed new range to the CRNC.

In FIG. 7, a controlling Radio Network Controller (CRNC) 700 comprises communication circuitry 791 to communicate with other radio network and core network nodes, memory 793 to store information, and a processing unit 792.

In accordance with solution A, the communication circuitry 791 is arranged to receive at least one range of E-DCH Radio Network Transaction Identifier (E-RNTI) for a common Enhanced Dedicated Channel) E-DCH resources provided by a base transceiver station (Node B). The processor 792 is arranged to allocate the E-RNTI within the range provided by Node B for the common E-DCH users.

In accordance with solution B, the processor 792 is arranged to configure the common E-DCH resource. The configuration comprises pre-deciding the E-RNTI ranges for the common E-DCH resources to use. Further, the communication circuitry 791 is arranged to send at least one range of the E-RNTI for the common E-DCH resources to the CRNC. In one option, the communication circuitry 791 is also arranged to receive a response from Node B to the sent at least one range of the E-RNTI for the common E-DCH resources. In one example the response is a confirmation message. In an alternative example, the response comprises at least one proposed new range.

In the above description, the specific terms such as Node B, CRNC and UE are used herein, but it should be understood that other terms may be used in different standards or protocols to refer to the same or like entities.

### ABBREVIATIONS

3GPP 3^{rd} Generation Partnership Project
CCCH Common Control Channel
DCCH Dedicated Control Channel
DCH Dedicated Channel
DTCH Dedicated Traffic Channel
E-DCH Enhanced Dedicated Channel
FACH Forward Access Channel
RACH Random Access Channel
RLC Radio Link Control
RRC Radio Resource Control Protocol
UE User Equipment
FDD Frequency Division Duplexing
UTRA UMTS Terrestrial Radio Access
NODE B Base transceiver station
RNC Radio Network Controller
CRNC Controlling RNC
NBAP Node B Application Part
RNSAP Radio Network Subsystem Application Part
lur The interface between RNCs in the same network
lub The interface between the RNC and the Node B
E-RNTI E-DCH Radio Network Transaction Identifier

1. A base transceiver station, node B, arranged to set up common Enhanced Dedicated Channel, E-DCH, resources in a cellular network, wherein the node B is arranged to
configure the common E-DCH resources comprising deciding at least one E-DCH Radio Network Transaction Identifier, E-RNTI, range for the common E-DCH resources, and
send the at least one E-RNTI range for the common E-DCH resources to a Controlling Radio Network Controller, CRNC so as to set up the common E-DHC resources.

2. A node B according to claim 1, wherein each at least one range comprises two values representing the start and end of the E-RNTI value for the common E-DCH resources.

3. A node B according to claim 1 arranged to send the at least one E-RNTI range in a Node B Application Part, NBAP, message.

4. A node B according to claim 3 arranged to send the at least one E-RNTI range in a NBAP message as new protocol information elements (IEs).

5. A node B according to claim 1, comprising
a processor arranged to configure the common E-DCH resources comprising deciding the at least one E-RNTI ranges for the common E-DCH resources to use,
a memory arranged to store information about the decided E-RNTI ranges for the common E-DCH resources to use, and
communication circuitry arranged to send the at least one range of the E-RNTI for the common E-DCH resources to the CRNC.

6. A system for setting up common Enhanced Dedicated Channel, E-DCH, resources in a cellular network, said system comprising at least one base transceiver station, node B, and at least one controlling Radio Network Controller, CRNC, wherein the at least one node B is arranged to configure the common E-DCH resource comprising deciding at least one E-DCH Radio Network Transaction Identifier, E-RNTI, range for the common E-DCH resources to use and to send the at least one E-RNTI range for the common E-DCH resources to its CRNC, so as to set up the common E-DHC resources.

7. A system according to claim 6, wherein each range comprises two values representing the start and end of the E-RNTI value for the common E-DCH resources.

8. A system according to claim 6 arranged to send the at least one E-RNTI ranges in a Node B Application Part, NBAP, message as new protocol information elements (IEs).

9. A system according to claim 6, wherein the at least one node B comprises
a processor arranged to configure the common E-DCH resource comprising deciding the at least one E-RNTI range for the common E-DCH resources to use,
a memory arranged to store information about the decided at least one E-RNTI range for the common E-DCH resources to use, and
communication circuitry arranged to send the at least one E-RNTI range for the common E-DCH resources to the CRNC.

10. A system according to claim 6, wherein the at least one CRNC is arranged to receive the range of the E-RNTI for the common E-DCH resources provided by the node B and to allocate the E-RNTI within the at least one range provided by the node B for the common E-DCH users.

11. A system according to claim 10, wherein the at least one CRNC comprises communication circuitry arranged to receive the at least one E-RNTI range for the common E-DCH resources provided by the node B and a processor arranged to allocate the E-RNTI within the at least one range for the common E-DCH users provided by the node B.

12. A system according to claim 6, wherein the cellular network is a UMTS Terrestrial Radio Access Network, UTRAN.

13. A method in a cellular network for setting up common Enhanced Dedicated Channel, E-DCH, resources, comprising performing at a node B the steps of
configuring the common E-DCH resource comprising deciding at least one E-DCH Radio Network Transaction Identifier, E-RNTI, range for the common E-DCH resources to use and
sending the at least one E-RNTI range for the common E-DCH resources to a Controlling Radio Network Controller, CRNC.

14. A method according to claim 13, the at least one range comprises each two values representing the start and end of the E-RNTI value for the common E-DCH resources.

15. A method according to claim 13, further comprising performing at the CRNC the steps of
receiving the at least one E-RNTI range for the common E-DCH resources provided by the node B and
allocating the E-RNTI within the at least one range provided by the node B for the common E-DCH users.

16. A controlling Radio Network Controller, CRNC, arranged to set up common Enhanced Dedicated Channel, E-DCH, resources in a cellular network, wherein the CRNC is arranged to configure the common E-DCH resources comprising pre-deciding at least one E-DCH Radio Network Transaction Identifier, E-RNTI, range for the common E-DCH resources and to inform a Base transceiver station, node B, about the pre-decided at least one range for the common E-DCH resources.

17. A system for setting up common Enhanced Dedicated Channel, E-DCH, resources in a cellular network, said system comprising at least one Base transceiver station, node B, and at least one controlling Radio Network Controller, CRNC, wherein
the at least one CRNC is arranged to configure the common E-DCH resource comprising pre-deciding at least one E-DCH Radio Network Transaction Identifier, E-RNTI, range for the common E-DCH resources and to inform a Base transceiver station, node B, about the at least one E-RNTI range for the common E-DCH resources, and
the node B is arranged to coordinate the at least one E-RNTI range for the common E-DCH resources decided by the CRNC and an E-DCH Radio Network Transaction, E-RNTI, for Cell Dedicated Channel, DCH, users and based thereon determine whether the at least one E-RNTI range for the common E-DCH resources pre-decided by the CRNC is acceptable.

18. A system according to claim 17, wherein the at least one E-RNTI range for the common E-DCH resources is determined to be acceptable, the node B is arranged to accept the at least one range without responding to the CRNC.

19. A system according to claim 17, wherein the at least one E-RNTI range for the common E-DCH resources is determined to be acceptable, the node B is arranged to actively confirm the at least one range in a response to the CRNC.

20. A system according to according to claim 17, wherein the at least one E-RNTI range for the common E-DCH resources is determined not to be acceptable, the node B is arranged to provide at least one proposed new range and to comprise the at least one proposed new range in a response to the CRNC.

21. A method for setting up common Enhanced Dedicated Channel, E-DCH, resources comprising
configuring at a Controlling Radio Network Controller, CRNC, the common E-DCH resource, said configuring comprising pre-deciding at least one E-DCH Radio Network Transaction, E-RNTI, range for the common E-DCH resources to use and
sending the at least one E-RNTI range for the common E-DCH resources to a Base transceiver station, node B.

22. A method according to claim 21, further comprising a step of receiving at the CRNC a response from the node B to the sent at least one E-RNTI range for the common E-DCH resources.

23. A method according to claim 22, wherein the response is a confirmation message or the response comprises a proposed new range.

24. A method according to claim 21, further comprising a step of
receiving at the node B the pre-decided at least one E-RNTI range for the common E-DCH resources provided by the CRNC, and
evaluating at node B the received pre-decided at least one range, and based on the evaluation determining the at least one E-RNTI range for the common E-DCH resources.

25. A method according to claim 23, further comprising a step of node B transmitting a confirmation response to the CRNC based on the evaluation.

26. A method according to claim 24, wherein node B forms at least one proposed new range based on the evaluation and transmits the proposed at least one new range to the CRNC.
